(19) United States
(12) Patent Application Publication
(10) Pub. No.: US 2025/0276898 A1
(43) Pub. Date: Sep. 4, 2025

(54) LITHIUM METAL PHOSPHATE POWDER AND METHOD TO MAKE IT

(71) Applicant: Wildcat Discovery Technologies, Inc., San Diego, CA (US)

(72) Inventors: Zhaohui Wu, San Diego, CA (US); Chuze Ma, San Diego, CA (US); Qizhang Yan, San Diego, CA (US)

(21) Appl. No.: 19/060,172

(22) Filed: Feb. 21, 2025

Related U.S. Application Data
(60) Provisional application No. 63/559,420, filed on Feb. 29, 2024.

(51) Int. Cl. C01B 25/45

(52) U.S. Cl. CPC C01B 25/45; C01P 2004/03; C01P 2004/62; C01P 2004/84; C01P 2006/40

(57) ABSTRACT

A carbon coated lithium metal phosphate (LMP) having improved characteristics may be made by a method comprising (i) milling a slurry comprised of LMP precursors and water, removing the water to form a mixture comprised of milled precursors, heating the mixture to an intermediate temperature of 200° C. to less than 400° C. to form an intermediate, mixing the intermediate with a carbon precursor in a solvent that dissolves the carbon precursor, removing the nonaqueous solvent to form a coated intermediate, and heating the coated intermediate to a reaction temperature of at least 400° C. to 1000° C. in a non-oxidizing atmosphere to form the carbon coated lithium manganese iron phosphate. The method enables the formation of carbon coated lithium manganese iron phosphate with electrochemical performance approaching theoretical even at larger average primary particle size utilizing commercially practicable production methods.

### CROSS REFERENCE TO RELATED APPLICATIONS

This application claims the benefit of U.S. Provisional Patent Application No. 63/559,420 filed on Feb. 29, 2024, the entire contents of which is incorporated herein by reference in its entirety.

### FIELD

The present invention relates to lithium metal phosphate powders useful for making lithium ion battery electrodes (e.g., lithium manganese iron phosphate) and methods to make the powder.

### BACKGROUND

Lithium iron phosphate (LiFePO₄) is a low cost material that is thermally stable and has low toxicity. It has demonstrated very high rate capability (high powder density) when made with a small particle size and narrow size distribution (submicron, typically 5 to 500 nm) and good carbon coating. For these reasons, lithium iron phosphate (“LFP”) has found use as a cathode material in lithium ion batteries. However, LFP has relatively low working voltage (3.4 V Li+/Li) and because of this has a low energy density relative to oxide cathode materials. In principle, the working voltage and therefore the energy density can be increased by substituting manganese for some or all of the iron to produce lithium manganese iron phosphate (LiₐMn_{b}Fe_{c}PO₄ (LMFP)). LMFP has, however, displayed poor electrical performance attributed to its low ion and electronic conductivity.

To realize performance approaching theoretical, LMFP has been coated with carbon by intensively milling precursors to a particle size of less than 100 nm and subsequently heating to form the LMFP. The process may be performed dry such as described in U.S. Pat. No. 8,784,694 in a planetary mill requiring complex costly equipment. The process may be one that includes mixing a slurry of precursors (e.g., FePO₄, Li₂CO₃, sugar,) in water, wet-milling the aqueous slurry in a bead mill (also complex costly equipment clone to clogging and low solids loading of the milling slurry), removing the water from the slurry (e.g., spray drying), heating the resulting dry material in a kiln under an inert atmosphere such as described by U.S. Pat. No. 9,960,413.

Accordingly, it would useful to provide a method of forming lithium metal phosphate (e.g., LMFP) characteristics at reduced cost (e.g., reduced energy usage and increased throughput).

### BRIEF SUMMARY

It has been discovered that improved carbon coated lithium metal phosphate (LMP) such as lithium iron phosphate (LMFP), inclusive of dopant metals (typically less than 2% by mole of the LMP may be made by a method that involves much less intensive milling resulting in larger particle size (greater than 100 nm average particle size “equivalent spherical diameter”) yet achieving desirable electrochemical performance. The method typically involves milling in less intensive milling such as an attritor mill, vibratory mill or rolling ball mill, precursors of the LMP which may be done in the absence of a carbon precursor that are then heated to a low temperature sufficient to partially react the LMP precursors (those used to form the intermediate, which is preferably done in the absence of a carbon precursor). These may then be coated with a carbon precursor and heated to a LMP reaction temperature greater than the low temperature used to form the intermediate. This surprising improvement is believed at least in part, without being limiting, due to the reaction chemistry occurring at the LMP reaction temperature (e.g., above 400° C.) as a result of forming the intermediate and then reacting in the presence of the carbon precursor to form the carbon coated lithium metal phosphate.

An illustration of the method to form a carbon coated lithium manganese iron phosphate comprises: (i) milling a slurry comprised of LMP precursors and water, (ii) removing the water to form a mixture comprised of milled precursors, (iii) heating the mixture to a temperature of 300° C. to less than 350° C. to form an intermediate, (iv) mixing the intermediate with a carbon precursor in a solvent, (v) removing the solvent to form a coated intermediate, and (vi) heating the coated intermediate to a temperature of at least 400° C. to 700° C. in a non-oxidizing atmosphere to form the carbon coated lithium manganese iron phosphate. The intermediate and subsequent LMFP may have an average particle size greater than 100 nm and typically less than 2 micrometers, 1 micrometer or 500 nm.

In another illustration, it has been discovered that the following LMFP powder comprising an average particle size of 100 nanometers to 1 micrometer, an amount of carbon of 1% to 20% by weight of the carbon coated manganese iron phosphate, and a formula:

LiₐMn_{b}Fe_{c}D_{d}PO₄

where a is a from 0.9 to 1.15, b is from 0.7 to 0.6, c is from 0.3 to 0.4, d is 0.001 to 0.02 and D is comprised of Nb and Mg. This LMFP displayed improved electrochemical performance even though having a larger particle size.

Herein, when a majority is specified of a component, it means more than 50% by mole or (readily understood from the context used) to essentially all of that component (99% or less). That is, the majority specified constituent of a component is present in an amount greater than 50% to 99%, 90, 80%, 70% or 60% of that component. When a minority of a component is a specified constituent, it is present in an amount less than 50% to about 1% with the balance being the majority specified constituent.

The composition may be used to form carbon coated LMP particles for use in primary and secondary batteries lithium ion batteries. The resultant carbon coated LMP particles may be used with any suitable electrolyte, separator and anode such as those known in the art.

### BRIEF DESCRIPTION OF THE DRAWINGS

FIG. 1 shows the initial capacity of batteries comprised of carbon coated lithium manganese iron phosphate (LMFP) of this invention.

FIG. 2 shows the initial energy of batteries comprised of carbon coated LMFP of this invention.

FIG. 3 shows the initial capacity of batteries comprised of carbon coated iron phosphate (LMFP) of this invention.

FIG. 4 shows the initial energy of batteries comprised of carbon coated LMFP of this invention.

FIG. 5 shows the differential scanning calorimetry (DSC) and thermogravimetric analysis (TGA) of lithium metal phosphate precursors without carbon.

FIG. 6 shows the initial capacity of batteries comprised of carbon coated LMFP of this invention.

FIG. 7 shows the initial energy of batteries comprised of carbon coated LMFP of this invention.

FIG. 8 shows the initial capacity of batteries comprised of carbon coated LMFP of this invention.

FIG. 9 shows the initial energy of batteries comprised of carbon coated LMFP of this invention.

FIG. 10 shows the initial charge/discharge profiles of batteries made of the carbon coated LMFP of this invention.

FIG. 11 is a scanning electron micrograph (SEM) of a carbon coated LMFP of this invention.

FIG. 12 is a scanning electron micrograph of a carbon coated LMFP of this invention.

### DETAILED DESCRIPTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at 30 degrees C., unless the context clearly dictates otherwise.

Ranges presented herein are inclusive of their endpoints. Thus, for example, the range to 3 includes the values 1 and 3 as well as the intermediate values.

Forming the carbon coated LMP comprises milling a slurry comprised of water and LMP precursors, and preferably in the absence of carbon precursors, removing the water to form milled precursors that are heated to a low temperature greater than 225° C., 250° C. or 300° C. to at most 350° C., 375° C., or 400° C. to form an intermediate. The drying and forming of the intermediate may be a combined step. To form the intermediate, LMP precursors are milled in water. The milling is desirably performed in less intensive milling processes (e.g., rolling mills, vibratory mill and attritor mills) resulting in the average particle size of the milled precursors being greater than 100, 200 or 300 nm to any practical size, but generally less than 5, 3 or 2 micrometers. Illustratively, the LMP precursor particles have a D₉₀ by volume of 0.5 to 5, 3, 2 or 1.5 micrometer. D₉₀ means the particle size (equivalent spherical diameter) in the particle size distribution, where 90% by volume of the particles are less than or equal to that size; similarly, the D₁₀ is at least 100 nm.

The particle size may be determined by any suitable method such as those known in the art including, for example, laser diffraction or image analysis of micrographs of a sufficient number of particles (˜100 to ˜200 particles). A representative laser diffractometer is one produced by Microtrac such as the Microtrac S3500. An Example of a suitable micro bead mill is a Buhler PML2 mill (Buhler Group).

The milling because of the less intensive methods (or shorter times/energy) of milling that may be employed as well as the larger milling media size that may be used, allows for the aqueous slurry to have a higher solids loading than typically possible when using a bead/sand mill, which commonly has milling media that is less than 1 mm or 0.5 mm in diameter. Likewise, the use of larger media (at least 2, 3, or 5 mm to any practicable size such as 25 mm) may allow for improved control of contamination of the precursors from the milling media. Illustratively, the solids loading of the aqueous milling slurry is greater than 10%, 15%, 20%, 25%, or 30% to any practicable amount, 70%, 60% or 50% solids loading by weight. The use of such less intensive media and larger sized carbon coated LMP having improved electrochemical performance compared to carbon coated LMP prepared from precursors subject to high intensity milling to reduce the particle size of the milled LMP precursors to less than 100 nm is surprising. Illustratively, the milling apparatus may be any commercially available attritor, roll mill or vibratory mill, which may be operated batch wise or continuously.

The LMP precursors may be any compounds that are useful react to make lithium metal phosphate powders. Some or all of the LMP precursors may be sources for two or more of the necessary elements to form the LMP. Suitable lithium precursors include, for example, lithium hydroxide, lithium oxide, lithium carbonate, lithium dihydrogen phosphate, lithium hydrogen phosphate, and lithium phosphate. Lithium dihydrogen phosphate, lithium hydrogen phosphate, and lithium phosphate all provided a source for both lithium ions and HₓPO₄ ions, and can be formed by partially neutralizing phosphoric acid with lithium hydroxide prior to being combined with the rest of the LMP precursors.

Suitable manganese precursors include manganese (II) compounds such as, for example, manganese (II) phosphate, manganese (II) hydrogen phosphate, manganese (II) dihy-drogen phosphate, manganese (II) carbonate, manganese (II) hydrogen carbonate, manganese (II) formate, manganese (II) acetate, manganese (II) oxide, manganese (II) glycolate, manganese (II) lactate, manganese (II) citrate and manga-nese (II) tartrate. Manganese (II) hydrogen phosphate and manganese (II) phosphate will also function as all or part of the precursor for HₓPO₄ ions, and can be formed by partially neutralizing phosphoric acid with manganese metal prior to being combined with the rest of the LMP precursors.

Suitable iron precursors include iron (II) phosphate, iron (II) hydrogen phosphate, iron (II) dihydrogen phosphate, iron (II) carbonate, iron (II) hydrogen carbonate, iron (II) formate, iron (II) acetate, iron (II) oxide, iron (II) glycolate, iron (II) lactate, iron (II) citrate, iron (II) tartrate. Iron (II) hydrogen phosphate and iron (II) phosphate will also function as all or part of the precursor for HₓPO₄ ions, and can be formed by partially neutralizing phosphoric acid with iron metal prior to being combined with the rest of the LMP precursors.

Suitable precursors for the dopant metals, when used, such as Nb and Mg include, for example, phosphate, hydrogen phosphate, dihydrogen phosphate, carbonate, formate, acetate, glycolate, lactate, tartrate, oxalate, oxide, hydroxide, fluoride, chloride, nitrate, sulfate, bromide and like salts of the various dopant metals. Examples include, for example, magnesium sulfate, magnesium phosphate, magnesium hydrogen phosphate, magnesium dihydrogen phosphate, magnesium carbonate, magnesium formate, magnesium acetate and niobium analogs. The phosphates, hydrogen phosphates and dihydrogen phosphates in the foregoing list will in addition to serving as a source of the dopant metal ion also will serve as some or all of the source of HₓPO₄ ions.

Suitable precursors for HₓPO₄ ions include, in addition to the hydrogen phosphate and dihydrogen phosphate compounds listed above, phosphoric acid, tetraalkyl ammonium phosphate compounds, tetraphenyl ammonium phosphate compounds, ammonium phosphate, ammonium dihydrogen phosphate, and the like.

The water is removed from the milled slurry by any useful method of removing water to realize the milled LMP precursors. The water removal may be any method such as those known in the art such as heating to above the boiling point of water but below where the precursors react (less than about 200° C. to ambient evaporation temperature), ambient drying, vacuum drying and the like. Because there may be dissolved species, the method of removal desirably causes such dissolved species to precipitate out during the water removal process.

The dried milled LMP precursors are then heated to a temperature sufficient to decompose and partially react the LMP precursors, preferably, in the absence of a carbon precursor to form an intermediate. This intermediate reaction temperature generally is at least about 250° C. or 300° C. to 350° C., 375° C., or less than 400° C. The time at the intermediate temperature may be any useful to partially react the LMP precursors to form the intermediate. Typically, this intermediate temperature is as fastest practical such as several (3-5) seconds or minutes to any useful such as 24 hours, 10 hours, 5 hours, 2 hours or 1 hour. The intermediate typically displays a weight of 90% to 80% or 75% compared to the weight of the LMP precursors. Further heating typically causes the weight to further decrease by 5% or more to at most about 25% when forming the LMP in the absence of carbon.

The intermediate and a carbon precursor are mixed in a solvent that substantially fails to dissolve (fails to alter the composition stoichiometry) any of the intermediate and preferably substantially fails to dissolve (e.g., solubility of less than 1% by weight at ambient conditions “˜20-25° C. and ˜1 atm of pressure) the carbon precursor to avoid precipitation of the carbon precursor when drying, which may, without be limiting, lead to non-uniform coating of the carbon precursor when subsequent heating to decompose the carbon precursor, when forming the carbon coated LMP. The milling of a solid carbon precursor that melts (i.e., flows) prior to carburization (decomposition of the precursor to form carbon) is believed to be desirable in bonding with the intermediate as it undergoes further reaction to form the coated carbon LMP. The solvents may include polar solvents or apolar solvents depending on the carbon precursor(s). Illustrative a polar protic (e.g., alcohol) and polar aprotic solvents may be particularly useful when the carbon precursor is comprised of a sugar such as glucose, sucrose, lactose and the like. Illustratively, the alcohol may be ethanol, methanol, propanol and combinations thereof.

The solvent may then be removed by any suitable method such as described above (e.g., spray drying and vacuum drying) to form a coated intermediate. The spray drying may be performed using any known commercially available spray dryer such as a mini spray dryer, such as the Buchi B-290 model.

The coated intermediate may then be heated to a reaction temperature to form the carbon coated LMP particles. Desirably, the temperature and time are such that the resulting LMP retains, when used, the micro-sized, spray dried secondary particle morphology. The reaction temperature may be from 400° C. to 1000° C., 900° C., 800° C., or 700° C.° C. for a time period from 10 min, 1, 2, 3, or 5 hours to 12 or 24 hours. The method of heating the composition may include one hold or slower rate through the temperature range depending on the carbon precursor employed. Generally, the heating rate is at least about 1° C./minute and any holds typically are from 5 minutes, 15 minutes to 6 hours, 4 hours or 2 hours.

The heating to carbonize the carbon precursor of the coated intermediate may be performed under any suitable non-oxidizing atmosphere, which may be static or flowing. The atmosphere may be a noble gas, nitrogen, reducing atmosphere (e.g., one comprised of H₂ or CO) and any combinations thereof to realize a desired partial pressure of one or more gases.

The carbon precursor is desirably one that decomposes under a non-oxidizing atmosphere to form carbon during the heating to the reaction temperature to form the carbon coated LMP. The carbon precursor may be comprised of one or more carbon precursors. Exemplary carbon precursor may include carboxylic acids or derivatives thereof (e.g., esters). The carboxylic acid may be saturated or unsaturated (e.g., linoleic acid). Desirably, the carboxylic acid or derivative thereof has from 8 to 24 carbon atoms. The carboxylic acid or derivative thereof may also desirably have 2 or more acid or hydroxyl groups to 10 or 6 such groups. The carbon precursors may be comprised of a nitrogen bearing organic carbon precursor and/or a hydroxyl bearing organic carbon precursor such as the carboxylic acid described above for the composition. The nitrogen bearing precursor illustratively may be an amine or amide. Exemplary nitrogen bearing precursors may include one or more of cyanoguanadine, melamine, urea, hexamethylene tetramine, trimethylamine, diethanolamine, triethanolamine, tetramethylenediamine, acetoguanamine, benzyldimethylamine, methylolmelamine, alkylated methylolmelamine, hexamethoxymethyl melamine, N,N′-dimethyl-p-phenylenediamine, tetraaminobenzene, diaminobenzidine, thiourea, formamide, acetamide, benzamide, oxamide, succinamide, malonamide, guanidine, biuret, triuret, dicyandiamide, biurea, ethylene urea, ammelide, ammeline, aminoguanidine, semicarbazide, thiosemicarbazide, cationic starch (amino modified starch) and acrylamide.

Exemplary hydroxyl bearing precursors may include sucrose, fructose, glucose, mannose, xylose, raffinose, dextrin, amylose, maltose, lactose, arabinose, dextrose, galactose, amylopectin, glucose polymers (glucans), xylose polymers (xylans), copolymers of glucose and xylose (gluco-xylans), invert sugar, partially invert sugar, molasses from sucrose refining, whey from milk processing, corn syrup, starch, modified starch, methylcellulose, cellulose acetate, ethylcellulose, hydroxypropylmethylcellulose, hydroxyethylcellulose, sodiumcarboxymethylcellulose, carboxymethylcellulose, cationic starch, and soy protein.

The composition may be further comprised of particulate carbon such as acetylene black, carbon black, carbon fiber, graphite, carbon nano-tube KJ600, and/or the like. The one or more carbon precursors may be present at a ratio in which the resultant LMP represents a majority and the carbon is the minority by volume or weight of the carbon coated LMP. For example, the weight or volume ratio of the carbon may be 60:40, 70:30, or 75:25 to 99:1 or 95:5 LMP to the carbon in the carbon coated LMP.

Desirably the carbon coated LMP is comprised of secondary particle size ranges from 1 to 20 micrometers with the average size falling anywhere within the range (typical average size from 5 to 15 micrometers). Each of the secondary particles is an agglomeration of agglomerated primary particles. Agglomerated primary particles herein means that the primary particles are bonded at least in part by chemical bonds requiring substantial impact to fracture and comminute the particles. The amount of carbon in the secondary particles or composition may be any useful amount and typically is at least 1%, 2%, 5% to 35%, 30% or 25% by volume carbon. Advantageously, the composition may be further comprised of unagglomerated LMP particles in amount of 5%, 10% 15%, to 35%, 30% or 25% by volume of the composition. The unagglomerated LMP particles desirably have the same size and particle size distribution as previously described herein. Such unagglomerated particles (not chemically bonded, but may be soft bonded, e.g., mechanically, van der Waals, hydrogen bonding or combination thereof), may be separately added or may be formed by agitating the secondary particles sufficiently abrade the primary particles from the secondary particles to realize the desired amount of unagglomerate LMP coated particles. The unagglomerated primary particles may be the same chemistry or a differing LMP chemistry, but desirably is the same chemistry (e.g., arising from LMP primary particles abraded from the secondary particles). Alternatively, the LMP powder may be essentially comprised of unagglomerated primary particles (at least 90%, 95% or 99% by weight or number).

The carbon coated LMP may be used to form a cathode by any suitable method such as those known in the art. For example, the carbon coated LMP powder may be mixed with a binder such a polymer useful to make cathodes (e.g., polyfluoropolymer such as polyvinylidene fluoride) one or more solvents to form a slurry. Non-limiting examples of the one or more solvents may be an aprotic polar solvent such as methyl-2-pyrrolidinone (NMP). The slurry may then be deposited on a metal current collector (e.g., stainless steel, copper, or any suitable conductive metal thin) and the solvent removed to form the cathode. A pressure may further be applied (calendaring).

The LMP cathode may be used in a rechargeable lithium ion battery cell. The battery cell includes the cathode, an anode, separator and electrolyte. The battery or battery cell may be formed in any suitable atmosphere such as common in the art. For example, a high purity argon atmosphere may be used to limit any undesirable contamination from species present in atmospheric air.

The method in a particular illustration desirably forms a carbon coated LMP powder having an average particle size of 100 nanometers to 1 micrometer (i.e. primary particle size), an amount of carbon of 1% to 20% by weight of the carbon coated lithium manganese iron phosphate powder, and a formula:

LiₐMn_{b}Fe_{c}D_{d}PO₄

where a is a from 0.9 to 1.15, b is from 0.7 to 0.6, c is from 0.3 to 0.4, d is 0 to 0.02 and, when D is present it is desirably comprised of Nb and Mg. Desirably, d is greater than 0 such as 0.001, 0.002, or 0.005 to 0.0175 or 0.015. Desirably, a is at least 0.95 or 1 to 1.1, or 1.05. When d is greater than 0, it is desirable for the D to be comprised of both Nb and Mg at a molar ratio of Nb/Mg of at least 01, 0.25, 0.5 to 10, 5, 2 or 1.5. Desirably the average primary particle size of the LMP is as described above and in particular the average primary particle size is greater than 100 nm to 1 micrometer or 500 nm. Desirably, b is 0.6 to 0.65 and c is 0.3 to 0.35.

### Examples

Various stoichiometry amounts of LMFP precursors (LiH₂PO₄, FeC₂O₄ (Iron oxalate), MnCO₃) are weighed, dispensed, and milled in attritor mill in water. The mixing speed and time is 750 rpm and 3 hours using 0.5 mm zirconia media and about 20% by weight solids loading. After mixing, the slurry is spray dried at 210° C. inlet temperature using a lab scale spray dryer as described herein. The spray dried powder is collected and annealed under N₂ atmosphere at 335° C. for 10 hours to form the intermediate. The intermediate is milled with 7.5 wt % (weight percent calculated based on final LMFP mass) glucose in ethanol with a high energy planetary ball mill for 3 hours at a solid loading of about 25% and then vacuum dried to remove the ethanol. The mixture is then heated to a reaction temperature of 600° C. to 650° C. for 7 hours under N₂ atmosphere to form carbon coated LMFP.

The carbon coated LMFP is mixed with carbon black (SuperP), PVDF (polyvinylidene difluoride) binder in NMP (N-methyl-2-pyrrolidone) in 90:5:5 weight ratio to form a slurry of about 20% solid content. The slurry is cast on an Al current collector and the NMP removed by heating at 110° C. The electrode was pressed in a hydraulic press and assembled in a half cell with a Li metal counter electrode, separator, and lithium-ion battery electrolyte. The areal capacity of the cathode is about 1 mAh/cm² (2.5 to 4.35 V). A battery cycler was used to test the electrochemical performance of the assembled coin cell with a charging of C/20 (C/100 CV) and discharging of C/20 at 25° C.

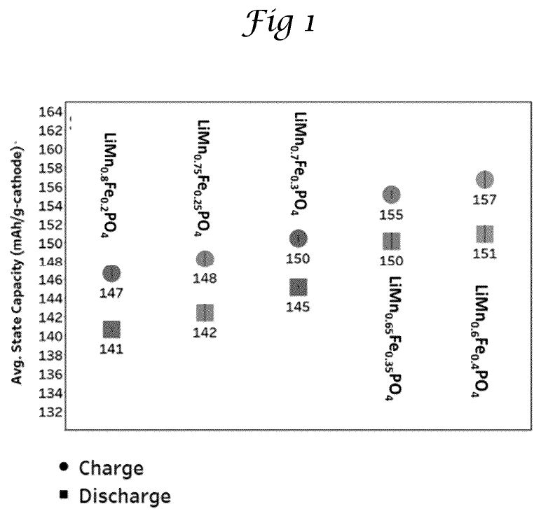

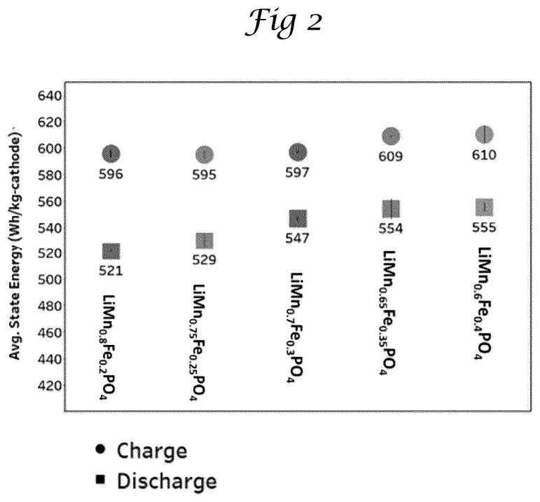

The electrochemical performance of these examples is shown in FIGS. 1 and 2. These cells show that the specific energy density is greatest at Mn/Fe molar ratio of 0.65/0.35.

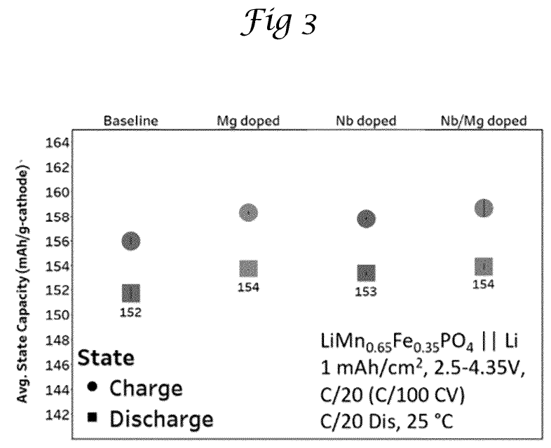

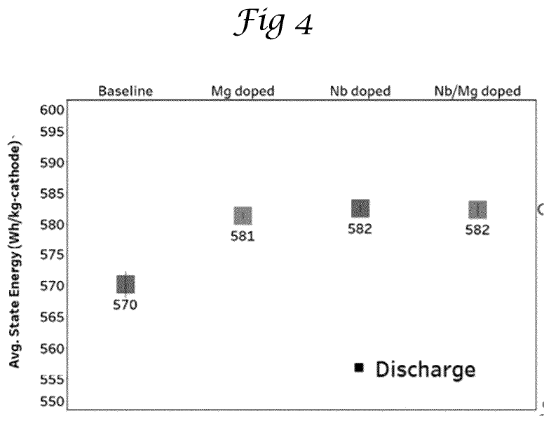

Carbon coated LMFP with a Mn/Fe molar ratio of 0.65/0.35 doped with 1% by mole of Nb, Mg and combination of Nb/Mg (1.5% by mole total) at a molar ratio of Nb/Mg of 1 are made and coin cells made therefrom are made as described above. The Mg and Nb precursors are magnesium acetate and niobium oxide, respectively. The results are shown in FIGS. 3 and 4. These results show that the batteries made from the doped carbon coated LMFP have further improvements compared to those without the doping (“Baseline” example in these Figures) in terms of specific capacity and specific energy density.

Carbon coated LMFP is attempted to be made by first milling the LMFP precursors as described above using a recirculating bead mill at a molar ratio of Mn/Fe of 0.65, but the mill clogged at a solids loading of 10% by weight using 0.3 mm ZrO₂ milling media.

Carbon coated LMFP is made by milling the LMFP precursors by ball milling in high energy planetary ball mill for 3 h using 5 mm ZrO₂ milling media at a solids loading of about 20% by weight. The ethanol is removed by vacuum drying and the intermediate is formed by annealing to 335° C. for 10 hours. The intermediate and glucose are milled in a micromedia bead mill (Buhler PML2 lab mill) in water at a solids loading of about 10% by weight for an energy input of 505 k Wh/t and then vacuum dried and heated to a reaction temperature of 600° C. to 650° C. for 7 hours under N₂ atmosphere to form carbon coated LMFP (referred to herein as Batch 2), which is made into coin cells and tested as described above.

Carbon coated LMFP is made at a larger scale in the same way as described above (attrition in water then ball milled in ethanol) and is referred to as Batch 3 herein. Coin cells are also made and tested as described above.

Carbon coated LMFP is made at a larger scale in the same way as described for Batch 3 except that 3% by mole excess Li is used and is referred to as Batch 4 herein. Coin cells are also made and tested as described above.

Carbon coated LMFP is made in the same way as Batch 3 except that 1.5% by mole of Nb and Mg total at a molar ratio of Nb/Mg=1 is used and is referred to as Batch 5 herein. Coin cells are also made and tested as described above.

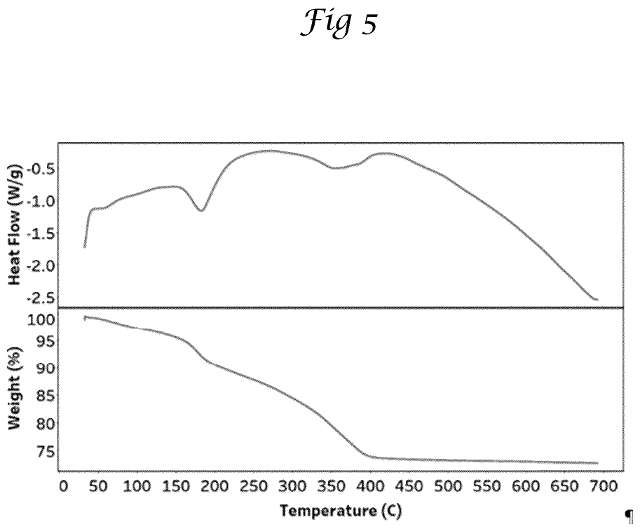

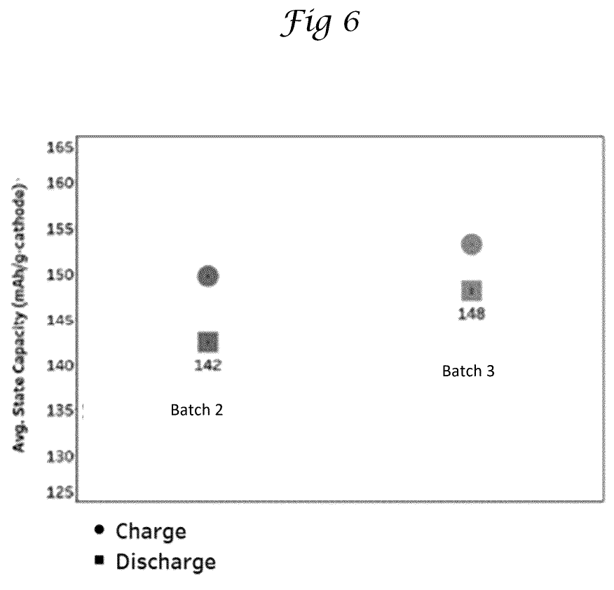

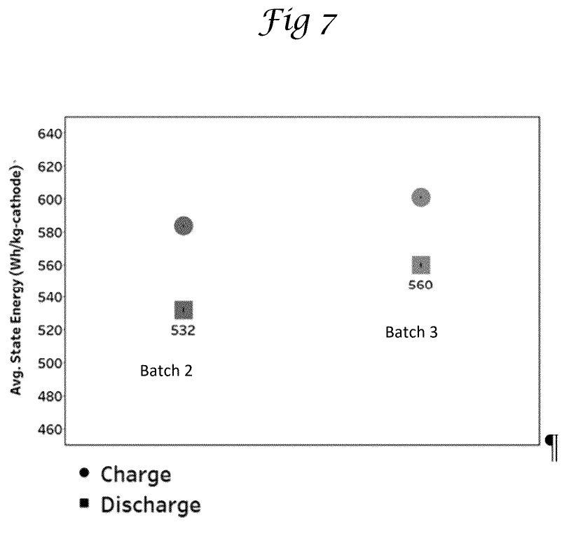

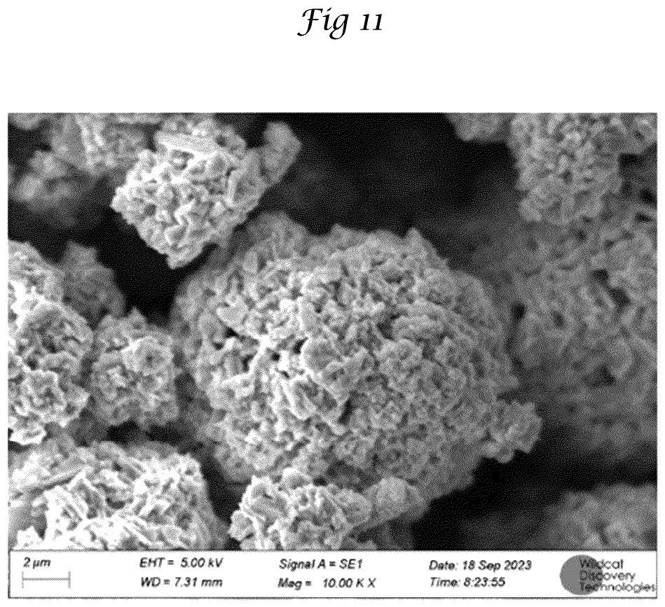

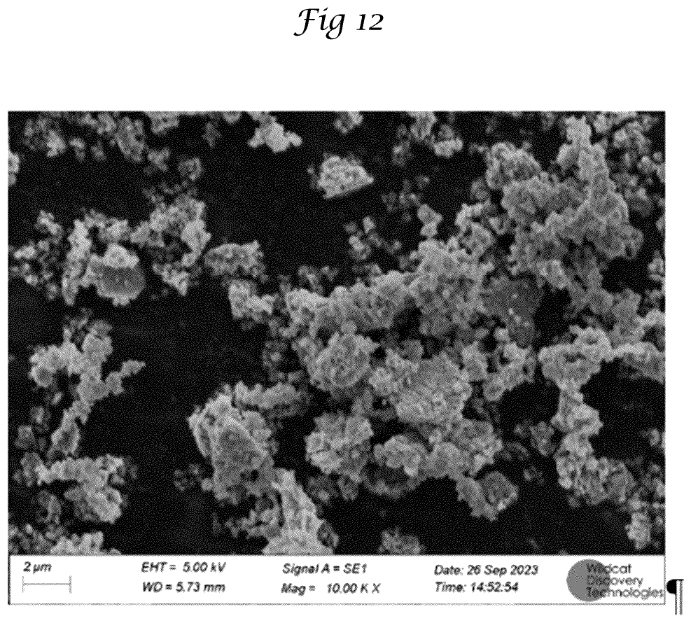

FIG. 5 shows the thermogravimetric analysis (TGA) weight loss and differential scanning calorimetry of the spray dried LMFP precursors (without the addition of the carbon precursor) in which the endothermic peak where the intermediate is formed extends beyond 400° C. FIGS. 6 and 7 show the initial electrochemical performance of batteries made from the coated LMFP of batches 2 and 3, where it can be seen that batch 3 has improved electrochemical performance even though less intense milling has been employed. FIGS. 11 and 12 (showing the carbon coated LMFP of batches 2 and 3 respectively) show that the batch 3 has a substantial amount of larger particles (˜2 micrometer) and a broader distribution of particles, while still surprisingly having even further improved electrochemical performance when attritor milling and using ethanol, which does not substantially dissolve the glucose, when coating the intermediate.

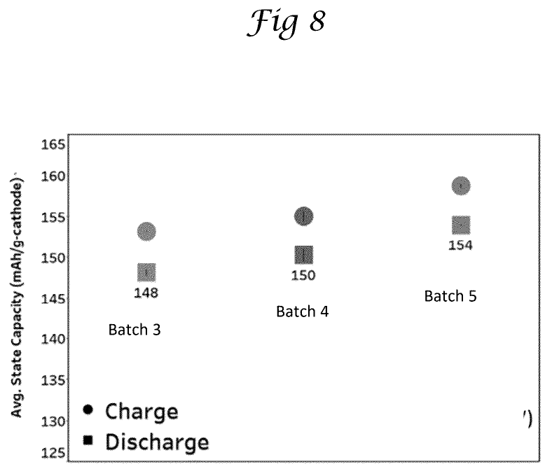

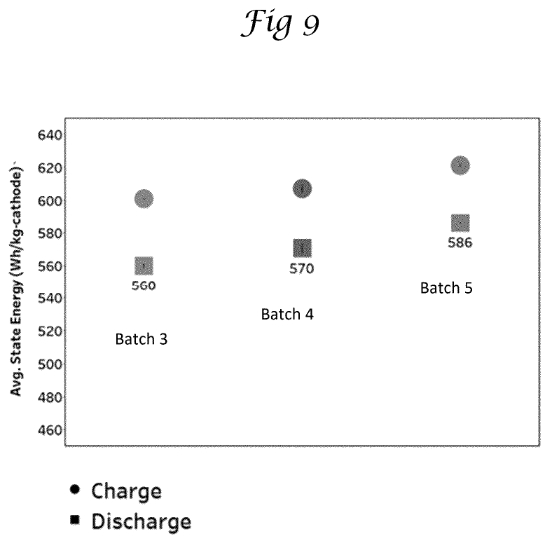

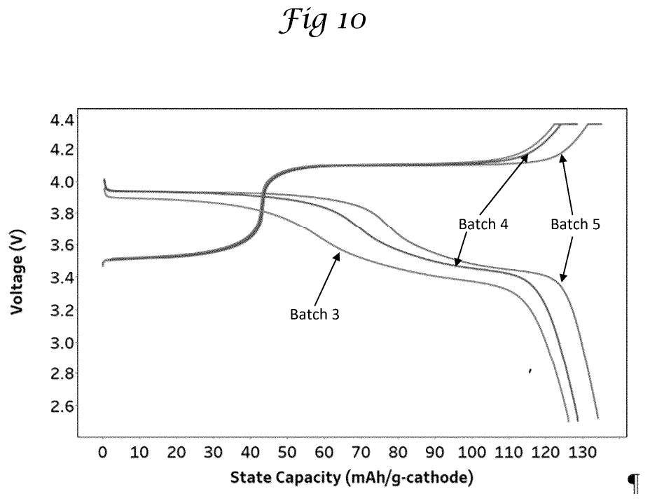

FIGS. 8-10 show the further initial electrochemical performance improvement of using a slight excess of lithium (batch 4) and doping with Nb and Mg with an excess of lithium as well. From FIGS. 8 and 9 it is evident the initial energy and capacity is increased from Batch 3. The voltage profile of FIG. 10 shows that at higher discharge (IC). Batch 5 has improved power delivery and charges to a higher capacity.

What is claimed is:

1. A method to form a carbon coated lithium manganese iron phosphate (LMP) comprising:
(i) milling a slurry comprised of LMP precursors and water,
(ii) removing the water to form a mixture comprised of milled precursors,
(iii) heating the mixture to an intermediate temperature of 200° C. to less than 400° C. to form an intermediate,
(iv) mixing the intermediate with a carbon precursor in a solvent,
(v) removing the solvent to form a coated intermediate, and
(vi) heating the coated intermediate to a reaction temperature of at least 400° C. to 700° C. in a non-oxidizing atmosphere to form the carbon coated lithium manganese iron phosphate.

2. The method of claim 1, wherein the carbon precursor is a solid that fails to be dissolved in the solvent and flows prior to decomposing upon heating to the reaction temperature.

3. The method of claim 1, wherein the carbon precursor is comprised of a sugar.

4. The method of claim 3, wherein the sugar is comprised of glucose.

5. The method of claim 1, wherein the solvent is comprised of a nonaqueous solvent.

6. The method of claim 5, wherein the nonaqueous solvent is comprised of an alcohol.

7. The method of claim 1, wherein the lithium manganese iron phosphate is represented by:
LiₐMn_{b}Fe_{c}D_{d}PO₄
where a is a from 0.9 to 1.15, b is from 0.7 to 0.6, c is from 0.3 to 0.4, d is 0.001 to 0.01 and D is comprised of at least one of Nb and Mg.

8. The method of claim 7, wherein a is greater than 1.

9. The method of claim 7, wherein D is comprised of Nb and Mg and Nb/Mg by mole is ½ to 2.

10. The method of claim 1, wherein the LMP precursors are comprised of lithium dihydrogen phosphate, iron oxalate, and manganese carbonate.

11. The method of claim 10, wherein the LMP precursors are further comprised of magnesium acetate and niobium oxide.

12. The method of claim 1, wherein the lithium manganese iron phosphate has an average primary particle size of greater than 100 nanometers to 1 micrometer.

13. The method of claim 1, wherein the carbon coated lithium manganese iron phosphate has an amount of carbon that is 1% to 20% by weight of the carbon coated lithium manganese phosphate.

14. A carbon coated lithium manganese iron phosphate powder having an average particle size of 100 nanometers to 1 micrometer, an amount of carbon of 1% to 20% by weight of the carbon coated manganese iron phosphate, and a formula:
LiₐMn_{b}Fe_{c}D_{d}PO₄
where a is a from 0.9 to 1.15, b is from 0.7 to 0.6, c is from 0.3 to 0.4, d is 0 to 0.02 and D is comprised of Nb and Mg.

15. The carbon coated lithium manganese iron phosphate powder of claim 14, wherein d is from 0.001 to 0.02.

16. The carbon coated lithium manganese iron phosphate powder of claim 14, wherein the average particle size is 100 nm to 500 nm.

17. The carbon coated lithium manganese iron phosphate powder of claim 14, wherein b is 0.6 to 0.65 and c is 0.3 to 0.35.

18. The carbon coated lithium manganese iron phosphate powder of claim 14, wherein Nb/Mg by mole is 12 to 2.

19. A cathode comprised of the carbon coated lithium manganese iron phosphate powder of claim 14.

20. A cathode comprised of the carbon coated lithium manganese iron phosphate made by the method of claim 1.
